(19) United States
(12) Patent Application Publication
(10) Pub. No.: US 2026/0269453 A1
(43) Pub. Date: Sep. 10, 2026

(54) ANTENNA MOUNTING SYSTEMS AND RELATED SECTOR FRAME MOUNTING SYSTEMS

(71) Applicant: Outdoor Wireless Networks LLC, Richardson, TX (US)

(72) Inventors: Shanguang Zhang, Suzhou (CN); Junfeng Yu, Suzhou (CN); Dongmin Wang, Suzhou (CN); Chen Chen, Suzhou (CN); Bingyang Li, Suzhou (CN)

(21) Appl. No.: 19/163,530

(22) PCT Filed: Jun. 25, 2023
(86) PCT No.: PCT/CN2023/102098

§ 371 Date: Sep. 9, 2025

(51) Int. Cl. H01Q 1/12

(52) U.S. Cl. CPC H01Q 1/1242; H01Q 1/1228

(57) ABSTRACT

An antenna mounting system with at least one longitudinally extending structure configured to attach an antenna and a separate communications device together and mount the antenna and communications device at a field site such as to a horizontal pole of a three-sector frame with an antenna tower or monopole. The antenna mounting system is configured to provide a lower front to back offset relative between the rear of the antenna and a support pole of the field mounting system and also position the rear of the communications device rearward of the pole of the field mounting system to reduce wind loading. The antennas may be base station antennas and the communications device can be an active antenna unit(s).

### FIELD OF THE INVENTION

The present invention relates generally to antenna mounting systems, and more particularly to mobile communications site mounting systems.

### BACKGROUND

Various types of towers have been constructed for the purpose of supporting one or more antennas, such as those for broadcasting television and radio signals. Some towers are specifically designed for transmitting and receiving cellular telephone signals and other types of radio frequency (RF) signals. Typically, RF towers are tall, self-supporting structures of one of two types: lattice towers and tubular monopole towers.

RF towers are often designed to allow a person to climb to the top and remain there to install and/or repair RF antennas (e.g., cellular antennas) and other equipment connected to the tower. Platforms are typically mounted near the tops of RF towers (e.g., cellular towers) for supporting workers who may be responsible for installing and/or maintaining RF antennas (e.g., cellular antennas). Such platforms are designed to support the weight of a human and may also be used to support a number of the RF antennas.

Exemplary platforms are described in U.S. Patent Publication No. 2011/0279347 to Pass et al., the disclosure of which is hereby incorporated herein in its entirety. The platform described in Pass et al. is a so-called “six-sector” platform. Most antenna arrangements include antennas that face away from the tower in three different directions separated by 120 degrees.

Recently, in the interest of increasing antenna density, some six-sector arrangements have been deployed, in which antennas are directed in six different directions at 60 degree intervals.

The sector frames may use combinations of horizontal and vertical support poles and provide a platform for ease of installation/servicing. See, U.S. Pat. No. 11,462,813, to Palmer et al., the contents of which are also incorporated herein in its entirety.

With the advent of 5G base station antennas, the weight and loading introduced by these devices may require some towers to be modified to accommodate the additional weight, which can be costly.

Based on the foregoing, it may be desirable to provide sector frame and antenna mounting configurations that provide a reduced front-to-back offset of an antenna relative to adjacent mounting structures that can reduce wind-loading and/or weight.

### SUMMARY

Embodiments of the invention are directed to a mounting system that couples an active antenna module to a passive antenna and that also positions the passive antenna and a front of the active antenna module in front of a mounting structure such as a pole and a rear of the active antenna module behind the mounting structure.

The mounting structure can be configured to attach to a horizontal pole(s) of a sector frame or other target field mounting structure.

Embodiments of the invention are directed to an antenna assembly that includes: an antenna; an active antenna module; and an antenna mounting system having a frame coupled to the antenna and the active antenna module with the active antenna module behind the antenna. The frame has a top short side that is attached to a field mounting structure or that merges into a pole segment that is attached to the field mounting structure. A rear of the active antenna module resides behind the field mounting structure.

The field mounting structure can have a horizontal pole and the top short side of the frame can be attached to the horizontal pole. Attachment hoops can be attached to the top short side of the frame and to a bracket that is also attached to the horizontal pole to thereby attach the top short side of the frame to the field mounting structure.

The top short side of the frame can merge into the pole segment and the rear of the active antenna module can reside behind the pole segment.

The pole segment can be an upper pole segment and the frame can have a bottom short side that can merge into a lower pole segment that is spaced apart from the upper pole segment.

The frame can have a perimeter that encloses a space and the mounting system can further include a frequency selective surface extending along and across at least part of the space.

Sidewalls of the frame can have a frequency selective surface.

Other aspects of the present invention are directed to an antenna mounting assembly that includes: a first vertical pole; a second vertical pole that is parallel and laterally spaced apart from the first vertical pole; an active antenna module positioned between and attached to the first and second vertical poles; and an antenna also attached to the first and second vertical poles, residing in front of the active antenna module. At least a rear surface of the active antenna module resides behind the first and second poles.

Yet other aspects of the present invention are directed to an antenna mounting assembly that includes: a first vertical pole segment; a second vertical pole segment; a first lateral member coupled to the first and second vertical pole segments; and an upper pole segment spaced apart from the first and second vertical pole segments and residing above the first lateral member. The upper pole segment can be configured to attach to a horizontal support pole of a sector frame; a communications device (e.g., an active antenna module) positioned between and attached to the first and second vertical pole segments. The antenna mounting assembly can also include an antenna attached to the first and second vertical pole segments, residing in front of the communications device (e.g., the active antenna module), wherein at least a rear surface of the communications device (e.g., the active antenna module) resides behind the first and second pole segments.

Still other aspects of the present invention are directed to an antenna mounting system that includes: a lateral member; at least one longitudinally extending mounting structure that is attached to the lateral member and that resides behind the lateral member a distance in a range of 2-8 inches to define a receiving space in front of the at least one longitudinally extending member. The at least one longitudinally extending member is configured to couple to an active antenna module.

Additional aspects of the present invention are directed to an antenna mounting system assembly that includes: an antenna mounting system having a frame with a perimeter extending about a space, an upper pole segment extending above a top side of the frame and a lower pole segment extending below a bottom side of the frame. The space has a length that is greater than a length of the upper pole segment and a length of the lower pole segment. The assembly also includes an antenna residing in front of the frame. At least one communications device is configured to couple to the frame and reside behind the antenna. At least part of the communications device resides in a plane that is behind the upper and lower pole segments.

The frame can have an access channel and aperture configured to receive a fastener to couple the frame to an antenna.

The at least one communications device can include at least one active antenna module. The space can have a length that is greater than a length of the active antenna module, and optionally the upper and/or lower pole segment can have a quick connect configuration to slidably engage a channel in a bracket attached to a field mounting pole.

The frame can have sidewalls with a frequency selective surface and/or a frequency selective surface that extends at least partially along and across the space.

Other aspects are directed to multi-sector mounting systems that include: a three-sector mounting assembly configured to mount to an antenna tower or monopole and comprising a plurality of horizontal poles configured to mount to the antenna tower or monopole, at least a first horizontal pole and a second horizontal pole spaced apart in a longitudinal direction, for each of the three sectors; and a plurality of antennas, at least two for each sector, each antenna comprising an antenna mounting system comprising at least one longitudinally extending support structure. The antenna mounting system of a respective antenna is attached to the first and second horizontal poles.

The antenna mounting system can further include a communications device mounted behind the antenna. A rear surface of the communications device can be positioned behind the first and second horizontal poles attached to the antenna mounting system.

The antenna mounting system can have a frame having a perimeter surrounding a space.

The frame can have a top side that is attached to the first horizontal pole.

The frame can have a bottom side that is longitudinally spaced apart from the top side and that can reside below the antenna. The bottom side of the frame can be attached to the second horizontal pole.

The sector mounting system can have first and second longitudinally spaced apart and vertically aligned upper and lower pole segments. The upper pole segment can be attached to the first horizontal pole and the lower pole segment can be attached to the second horizontal pole.

The antenna mounting system can have a frequency selective surface extending over at least a portion of the space.

Sidewalls of the frame can have a frequency selective surface.

The at least one longitudinally extending support structure can have a longitudinally extending support structure that resides behind a lateral support structure a distance in a range of 2-8 inches.

An active antenna module can be attached to at least one of the mounting systems, residing behind a respective one of the antennas, and a rear of the active antenna module can reside behind the first and second horizontal poles attached to the antenna mounting system that is also attached to the active antenna module.

At least some of the antennas can be base station antennas.

The sector mounting system can have a platform coupled to at least some of the horizontal poles.

At least one of the upper and/or lower pole segments can have a quick connect configuration configured with an upper plate configured to slidably engage a bracket attached to the first and/or second horizontal pole.

The three-sector mounting assembly can be configured to reside at a top of the antenna tower or monopole.

It is noted that any one or more aspects or features described with respect to one embodiment may be incorporated in a different embodiment although not specifically described relative thereto. That is, all embodiments and/or features of any embodiment can be combined in any way and/or combination. Applicant reserves the right to change any originally filed claim or file any new claim accordingly, including the right to be able to amend any originally filed claim to depend from and/or incorporate any feature of any other claim although not originally claimed in that manner. These and other objects and/or aspects of the present invention are explained in detail in the specification set forth below.

### BRIEF DESCRIPTION OF THE FIGURES

FIG. 1 is a side view of a prior art antenna mounting system according to embodiments of the invention.

FIG. 2 is a schematic side view of an antenna mounting system according to embodiments of the present invention.

FIG. 3 is a schematic side view of an antenna mounting system according to additional embodiments of the present invention.

FIG. 4 is a front view of an antenna mounting structure for the antenna mounting system shown in FIG. 2 or 3 according to embodiments of the present invention.

FIG. 5 is a front view of another embodiment of an antenna mounting structure for the antenna mounting system shown in FIG. 2 or 3 according to embodiments of the present invention.

FIG. 6 is a front view of another embodiment of an antenna mounting structure for the antenna mounting system shown in FIG. 2 or 3 according to embodiments of the present invention.

FIG. 7 is a front view of another embodiment of an antenna mounting structure for the antenna mounting system shown in FIG. 2 or 3 according to embodiments of the present invention.

FIGS. 8A-8C are front views of example mounting system configurations comprising a frame and upper and lower pole segments according to embodiments of the present invention.

FIGS. 9A-9C are front views of example mounting system configurations comprising an elongate frame that does not require upper and lower pole segments according to embodiments of the present invention.

FIGS. 10-17B are side perspective views of additional embodiments of mounting systems including spaced apart pole segments (FIGS. 10, 12, 14, 16A, 16B) and mounting systems without pole segments (FIGS. 11, 13, 15, 17A, 17B) according to embodiments of the present invention.

FIG. 18 is a side perspective view of a sector frame with an example antenna mounting system having a passive antenna coupled to an active antenna module using an antenna mounting structure that is also configured to couple to a horizontal pole(s) of the sector frame according to embodiments of the present invention.

FIG. 19A is a rear, side perspective view of the mounting system shown in FIG. 8A coupled to both a passive antenna and an active antenna module.

FIG. 19B is a side view of the assembly shown in FIG. 19A illustrating a reduced front to back offset according to embodiments of the present invention.

FIG. 19C is another side view of the antenna mounting system shown in FIG. 19A according to embodiments of the present invention.

FIG. 19D is a back, side perspective view of the antenna mounting system shown in FIG. 19C.

FIG. 20A is a rear, side perspective view of the mounting system shown in FIG. 10 coupled to both a passive antenna and an active antenna module.

FIG. 20B is a side view of the assembly shown in FIG. 20A illustrating a reduced front to back offset according to embodiments of the present invention.

FIG. 21A is a rear, side perspective view of the mounting system shown in FIG. 14 coupled to both a passive antenna and an active antenna module.

FIG. 21B is a side view of the assembly shown in FIG. 21A illustrating a reduced front to back offset according to embodiments of the present invention.

FIG. 21C is an enlarged side perspective view of a portion of the mounting system shown in FIGS. 21A and 21B.

FIG. 22A is a rear, side perspective view of the mounting system shown in FIG. 9A coupled to both a passive antenna and an active antenna module.

FIG. 22B is an enlarged side perspective view of the attachment interface shown in FIG. 22A.

FIG. 23 is a rear, perspective, partially exploded view of another embodiment of the mounting system aligned with the active antenna module and passive antenna according to embodiments of the present invention.

FIG. 24A is a side perspective view of another embodiment of a mounting system according to embodiments of the present invention.

FIG. 24B is a greatly enlarged view of a portion of a side of the mounting system shown in FIG. 24A.

FIG. 25A is a side perspective view of another embodiment of a mounting system according to embodiments of the present invention.

FIG. 25B is a greatly enlarged view of a portion of a side of the mounting system shown in FIG. 25A.

FIGS. 26A-26F illustrate an example sequence of mounting actions that can be used to mount components to a sector frame using mounting systems according to embodiments of the present invention.

FIGS. 27A-27D illustrate an example sequence of mounting actions that can be used to mount an antenna to a sector frame using mounting systems according to embodiments of the present invention.

FIGS. 28A-28E illustrate an example sequence of mounting actions that can be used to mount components to an installed antenna in position on a sector frame according to embodiments of the present invention.

FIG. 29 is a front, side perspective view of a portion of a sector frame illustrating an installation interface for attaching the mounting system according to embodiments of the present invention.

FIG. 30 is a front, side perspective view of a portion of a sector frame illustrating another embodiment of an installation interface for attaching the mounting system according to embodiments of the present invention.

FIG. 31 is a front, side perspective view of a portion of a sector frame illustrating another embodiment of an installation interface for attaching the mounting system according to embodiments of the present invention.

FIGS. 32A-32C are top, side perspective views of a top portion of the antenna mounting system and installation interface shown in FIGS. 18 and 30 illustrating an example sequence for field installation to a sector frame according to embodiments of the present invention.

FIG. 33 is a side view of the pole segment forming part of the antenna mounting system shown in FIG. 32A.

FIG. 34 is a top view of the bracket configured to slidably receive the pole segment, also shown in FIG. 32A.

FIG. 35 is a side view of a sector frame shown holding a plurality of antennas using respective mounting systems, the antennas provided on each of three sides and having a reduced front to back profile relative to the horizontal pole(s) of the sector frame according to embodiments of the present invention.

FIGS. 36A-36C are schematic side views of example mounting systems configured to mount multiple components of the same or different functionality/devices, e.g., active antenna modules, filter units RRU, TMX and the like according to embodiments of the present invention.

FIG. 37 is a rear, side perspective view of a prior art mounting system coupled to a vertical pole.

FIG. 38 is a rear, side perspective view of the prior art mounting system shown in FIG. 37 coupled to filter units and a radio (typically not beamforming) with the radio and filter units positioned entirely in front of the vertical mounting pole.

FIG. 39A is a side view of an example mounting system that positions the radio and filter units entirely behind a mounting structure and with an antenna in front of the mounting structure and that eliminates at least the center segment of the vertical pole shown in FIG. 37 according to embodiments of the present invention.

FIG. 39B is a back, side perspective view of the mounting system and antenna components shown in FIG. 39A.

FIG. 40 is a back view of the mounting system shown in FIG. 39A.

FIG. 41 is a back, side perspective view of the mounting system shown in FIG. 40, shown coupled to a passive antenna and to filter units and a radio according to embodiments of the present invention.

### DETAILED DESCRIPTION

The present invention now is described more fully hereinafter with reference to the accompanying drawings, in which embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

Like numbers refer to like elements throughout. In the figures, the thickness of certain lines, layers, components, elements or features may be exaggerated for clarity.

The terminology used herein is for the purpose of describing particular embodiments only and is not intended to be limiting of the invention. Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein. Well-known functions or constructions may not be described in detail for brevity and/or clarity.

As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. As used herein, phrases such as “between X and Y” and “between about X and Y” should be interpreted to include X and Y.

As used herein, phrases such as “between about X and Y” mean “between about X and about Y.” As used herein, phrases such as “from about X to Y” mean “from about X to about Y.” It will be understood that when an element is referred to as being “on”, “attached” to, “connected” to, “coupled” with, “contacting”, etc., another element, it can be directly on, attached to, connected to, coupled with or contacting the other element or intervening elements may also be present. In contrast, when an element is referred to as being, for example, “directly on”, “directly attached” to, “directly connected” to, “directly coupled” with or “directly contacting” another element, there are no intervening elements present. It will also be appreciated by those of skill in the art that references to a structure or feature that is disposed “adjacent” another feature may have portions that overlap or underlie the adjacent feature.

Spatially relative terms, such as “under”, “below”, “lower”, “over”, “upper”, “lateral”, “left”, “right” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is inverted, elements described as “under” or “beneath” other elements or features would then be oriented “over” the other elements or features. The device may be otherwise oriented (rotated 90 degrees or at other orientations) and the descriptors of relative spatial relationships used herein interpreted accordingly.

Also, as used herein, the terms “horizontal” and “vertical” are intended to encompass structures that may vary from precise horizontal or vertical orientations by a small amount (e.g., 5-10 degrees).

It will also be understood that, as used herein, the terms “example,” “exemplary,” and derivatives thereof are intended to refer to non-limiting examples and/or variants embodiments discussed herein and are not intended to indicate preference for one or more embodiments discussed herein compared to one or more other embodiments.

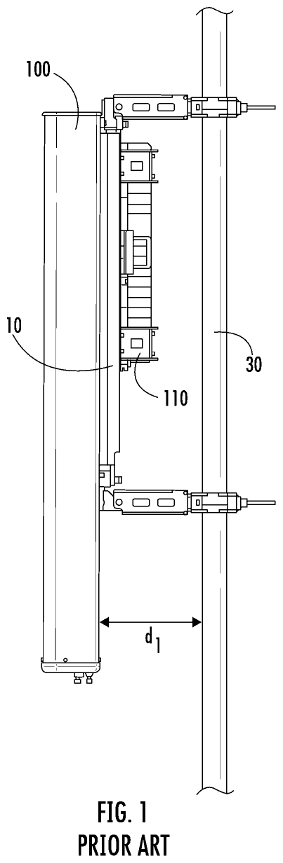

Referring now to the drawings, FIG. 1 shows a prior art mounting system 10 coupled to an antenna 100 and an active antenna module 110 and attached to a continuous length pole 30 with the antenna 100 and the active antenna unit 110 both residing entirely in front of the pole 30, providing a relatively large front to back offset distance d1.

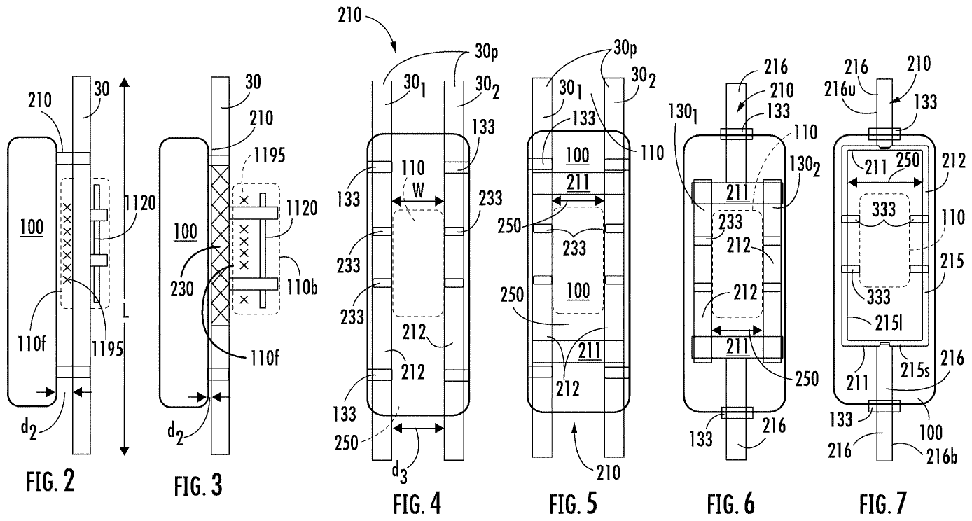

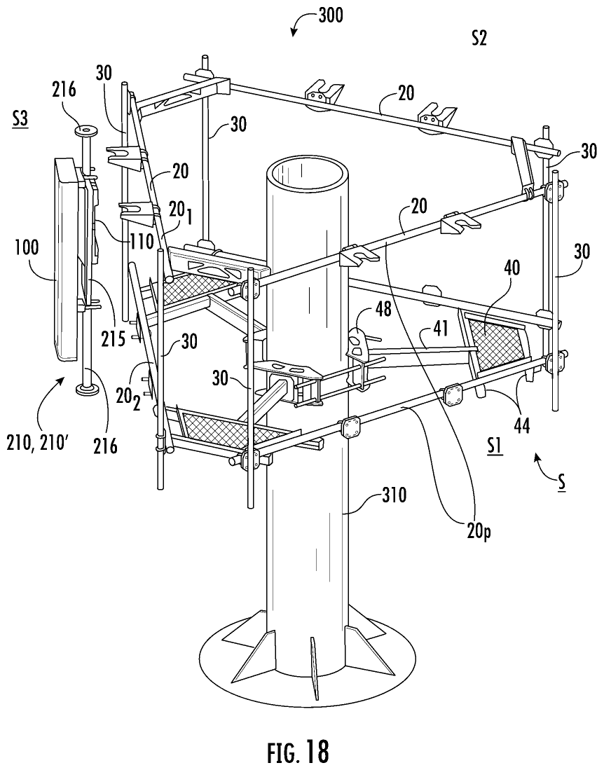

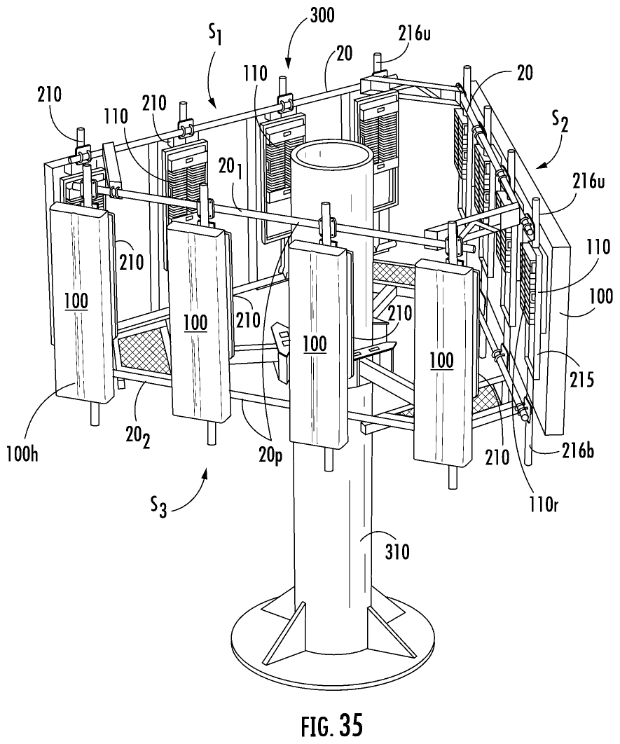

Referring to FIGS. 2 and 3, embodiments of the present invention provide a mounting system 210 that is configured to provide a smaller front to back offset d2 between the rear 100r of the antenna 100 and the target field mounting structure than conventional mounting systems. The mounting system 210 is configured so that at least part of the active antenna module 110, or other component mounted behind a rear of the antenna 100, resides behind a mounting structure of the mounting system 210 that is coupled to the active antenna module 110 (or other communication device) and the antenna 100 and is also configured to directly attach to a field support structure, such as a horizontal pole 20. As will be discussed further below, the mounting system 210 can be configured to directly attach to the horizontal pole(s) 20 of a sector frame 300 (FIGS. 18, 35).

Referring to FIG. 2, the mounting system 210 can be configured so that the antenna 100 resides entirely in front of but closely spaced apart a distance d2 from the vertical mounting structure, which as shown in FIGS. 4, 5 can be laterally spaced apart parallel poles 30, or as shown in FIGS. 6 and 7, pole segments 216, with the rear of the active antenna module 110 behind the poles 30. In some embodiments, the offset distance d2 can be in a range of 0.1-2 inches.

Referring to FIG. 3, the mounting system 210 can be configured so that a rear 100r of the antenna 100 is aligned with a forwardmost part of the vertical mounting structure, shown as poles 30 in FIGS. 4, 5, or is closely spaced apart a distance d2, where d2 is in a range of 0.0-1 inch and where the active antenna module 110 can reside entirely behind the poles 30 or pole segments 216 (FIGS. 6, 7).

FIG. 3 illustrates that, in some particular embodiments, particularly if a single vertical pole is used, at least a portion of the pole 30, positioned in front of the active antenna module 110, can be configured to have a frequency selective surface 230 whereby radiation from radiating elements 1195 (e.g., a MIMO array of radiating elements) in the active antenna module 110 can transmit through the FSS 230 of the pole 30 without affecting performance. The FSS 230 can be provided by a cylindrical, metal wall segment of the vertical pole 30 that is configured with unit cell structures.

The antenna 100 can be a base station antenna 100 according to certain embodiments of the present invention. In the description that follows, the base station antenna 100 will be described using terms that assume that the base station antenna 100 is mounted for use on a sector frame, tower, pole or other mounting structure with the longitudinal axis L of the base station antenna 100 extending along a vertical axis and the front 100f of the base station antenna 100 mounted to face outward, away from/opposite the sector frame, tower, pole or other mounting structure, pointing toward the target coverage area for the base station antenna 100 and the rear 100r of the base station antenna 100 facing the sector frame 300 with center tower 310 (FIGS. 18, 35) or other mounting structure. It will be appreciated that the base station antenna 100 may not always be mounted so that the longitudinal axis L thereof extends along a vertical axis. For example, the base station antenna 100 may be tilted slightly (e.g., less than 10°) with respect to the vertical axis so that the resultant antenna beams formed by the base station antenna 100 each have a small mechanical downtilt.

As discussed with respect to FIGS. 2 and 3, the mounting system 210 can be configured to couple to a base station antenna 100 and at least one active antenna module 110.

The term “active antenna module” is used interchangeably with “active antenna unit” and “AAU” and “active antenna” and refers to a cellular communications unit comprising radio circuitry and associated radiating elements with beamforming capability. The radio circuitry is capable of electronically adjusting the amplitude and/or phase of the subcomponents of an RF signal that are output to different radiating elements of an array or groups thereof. The active antenna module 110 comprises the radio circuitry 1120 and the radiating elements 1195 (e.g., a multi-input-multi-output (mMIMO) beamforming antenna array) (FIGS. 2, 3) and may include other components such as filters, a calibration network, an antenna interface signal group (AISG) controller and the like. The active antenna module 110 can be provided as a single integrated unit or provided as a plurality of stackable units, including, for example, first and second sub-units such as a radio sub-unit (box) with the radio circuitry and an antenna sub-unit (box) with a multi-column array of radiating elements and the first and second sub-units stackably attach together in a front to back direction of the base station antenna 100, with radiating elements 1195 closer to the front radome 100f of the housing 100h/radome of the base station antenna 100 than radio circuitry 1120 (FIGS. 2, 3). In some embodiments, the radiating elements 1195 may comprise a separate sub-unit from the radio circuitry and the radiating element sub-unit may be mounted within the base station antenna 100 instead of being external to the base station antenna 100.

The AAU radiating elements 1195 can be provided or comprise mMIMO radiating elements.

The base station antenna 100 includes an antenna assembly 190, which can be referred to as a “passive antenna assembly”. The term “passive antenna assembly” refers to an antenna assembly having arrays of radiating elements that are coupled to radios that are external to the antenna, typically remote radio heads that are mounted in close proximity to the base station antenna 100. The arrays of radiating elements included in the passive antenna assembly 190 are configured to form static antenna beams (e.g., antenna beams that are each configured to cover a sector of a base station). The passive antenna assembly 190 can comprise a reflector with radiating elements projecting in front of the reflector and the radiating elements can include one or more linear arrays of low band radiating elements that operate in all or part of the 617-960 MHz frequency band and/or one or more linear arrays of mid-band radiating elements that operate in all or part of the 1427-2690 MHz frequency band. The passive antenna assembly 190 is mounted in the housing 100h of base station antenna 100 and one or more active antenna modules 110 can reside behind, optionally releasably (detachably) couple (e.g., directly or indirectly attach) to base station antenna 100. See, e.g., U.S. Pat. No. 11,482,774 and U.S.

Patent Application Ser. No. 17/787,619, the contents of which are hereby incorporated by reference as if recited in full herein.

Turning now to FIGS. 4-7, schematic illustrations of example mounting systems 210 that can provide the reduced front to back offset d2 are shown. In these embodiments, the mounting system 210 has a laterally and longitudinally extending space 250 sized and configured to position the active antenna module 110 in the space 250, typically between laterally spaced apart, longitudinally extending mounting structures 212. FIG. 7 provides the longitudinally extending structures 212 as long sides of a frame 215. The lateral spacing d3 between neighboring or adjacent longitudinally extending mounting structures 212 can correspond to the width W of the active antenna module 110. The lateral spacing d3 can be +/−20% of the width W of the active antenna module 110, more typically, 1%-20% greater than the W of the active antenna 110.

FIGS. 4 and 5 show the longitudinally extending mounting structures 212 are provided by a pair 30p of first and second poles 301, 302 that are parallel. The antenna 100 is attached to the poles directly using brackets 133 and the active antenna module 110 is attached to the first and second poles directly using brackets 233, the brackets 233 are between the brackets 133.

FIG. 5 shows that the mounting system 210 can include at least one lateral member strut 211 (shown as an upper and lower lateral member 211) that is attached to the first and second poles 30₁, 30₂. The term “lateral member” is interchangeably referred to as a “lateral strut” herein.

FIG. 6 shows that the longitudinally extending mounting structures 212 can be provided by pole segments 130₁, 130₂, attached by lateral members 211. Upper and lower pole segments 216 can extend upwardly and downwardly, respectively, from a medial location of respective lateral members 211. The upper and lower pole segments 216 can have a length that is less than a length of the longitudinally extending mounting structures 212, e.g., the pole medially positioned pole segments 130₁, 130₂. This configuration can have less weight relative to FIGS. 4 and 5, for example. Brackets 133 can be used to attach the antenna 100 to the upper and lower pole segments 216. Brackets 233 can be used to attach the active antenna module 110 to the pole segments 130₁, 130₂.

FIG. 7 shows another mounting system 210 which provides a frame 215 with the longitudinally extending mounting structures 212 and the lateral members 211. The frame 215 can be an integral or monolithic structure providing four sides surrounding the space 250. The longitudinally extending mounting structures 212 provided by the long sides 215l of the frame 215 can be configured to have planar outer surfaces with cross-sections formed as “C” or “U” or “I” shaped struts for increased strength. The frame 215 can have long sides 215l and short sides 215s and the short sides 215s can be coupled to the top and bottom pole segments 216 as shown. The pole segments 216 can have a length that is less than a length of the long sides 215l of the frame 215, e.g., the longitudinally extending structures 212. The upper and lower pole segments 216u, 216b, respectively, can be laterally spaced apart across a length of the space 250. The active antenna module 110 can reside at least partially behind the space 250 and can be attached to the long sides 215l of the frame 215 using brackets 333. The antenna 100 can be attached to the pole segments 216 using brackets 133. However, other mounting attachments may be used. For example, the frame 215 can be configured to directly attach to the antenna using fasteners 135 (FIG. 21C) such as screws, rivets, pins or other fasteners without requiring brackets such as brackets 133.

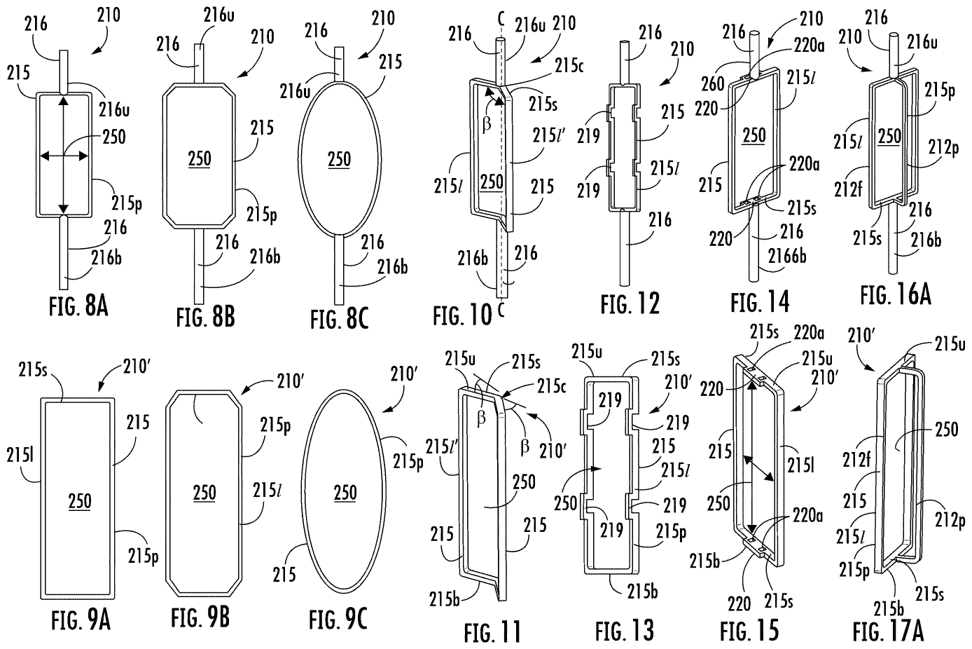

FIGS. 8A-8C show example variations of the mounting system 210 comprising the frame 215 with a perimeter 215p surrounding the space 250 and with the upper and lower, spaced apart pole segments 216u, 216b projecting outward from each respective short side 215s. The upper pole segment 216u can have a shorter length than the lower pole segment 216b. The upper pole segment and the lower pole segment 216u, 216b, respectively, can both have the same configuration. Alternatively, each can have a different configuration. The upper and lower pole segments 216u, 216b, respectively, can have a cylindrical configuration, e.g., circular cross-sectional shapes, or each can have flat or other cross-sectional shapes.

FIGS. 9A-9C show example variations of the mounting system 210′ comprising the frame 215 with a perimeter 215p surrounding space 250 with the mounting system 210 devoid of the upper and lower pole segments 216. The frame 215 without the upper and lower pole segments 216 can be longer and can provide a larger space 250 than the mounting system 210 with the pole segments 216. The upper side 215u and the lower side 215b of the frame 215, can be the short sides 215s of the frame 215 of the mounting system 210′ and can be configured to directly couple to field mounting structures such as respective horizontal poles 20 of a sector frame 300 (FIGS. 22A, 31).

FIGS. 10 and 11, show respective mounting systems 210, 210′ with frames 215 that have upper and lower (laterally extending) sides 215u, 215b that angle outwardly in a rearward direction from a center 215c at an angle ß from the center 215c and/or about a long axis C-C drawn between center points 215c of the upper and lower sides 215u, 215b, that can be in a range of 10-45 degrees, to position the long sides 215 l′ rearward of the center 215 c which can provide a smaller front to back offset between a rear 100r of the antenna 100 and the pole segments 216 (FIG. 20B) or otherwise reduced front to back profile relative to conventional mounting configurations when the mounting system 210′ shown in FIG. 11 is used without the pole segments 216.

FIGS. 12 and 13 show respective mounting systems 210, 210′ with frames 215 that have right and left side aligned pairs of stepped segments 219 that can couple to active antenna modules 110 to replace external brackets to hold the active antenna module 110 or other device to the frame 215 that can reduce cost and/or weight.

FIGS. 14 and 15 show respective mounting systems 210, 210′ with frames 215 that have integrated fastener segments 220 with apertures 220a provided in upper and lower frame segments 215u, 215b that can receive fasteners 135 (FIG. 21C) to attach the antenna 100 adjacent the respective pole segments 216 without requiring a clamp or other bracket.

FIGS. 14 and 15, for example, also show that the frames 215 can be configured to be planar and reside in a single, common plane, substantially coplanar with the rear 100r of the antenna 100.

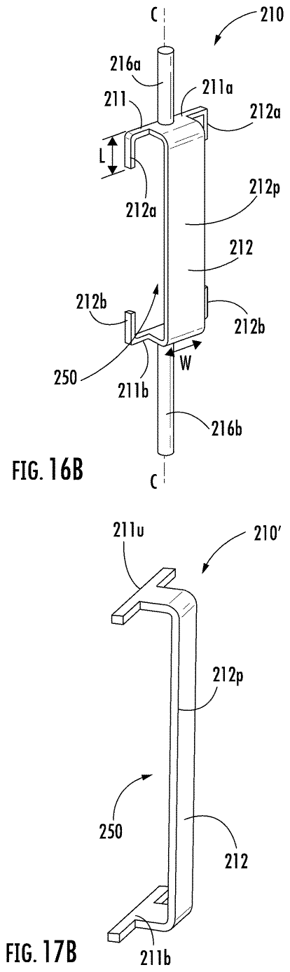

FIGS. 16A and 17A show respective mounting systems 210, 210′ with frames 215 that include a longitudinally extending rear structure 215p that is behind (typically orthogonal to) at least one long side 215/of the frame 215. This longitudinally extending rear structure 215p can have a length that extends between the top and bottom sides 215u, 215b of the frame 215 to provide improved rigidity or strength for the mounting system 210 and/or be configured to attach to an active antenna module 110 or other device.

FIGS. 16B and 17B show respective mounting systems 210, 210′ that do not require a frame 215 but provide lateral support structures 211 and at least one longitudinally extending support structure 212p that is positioned behind the upper and lower lateral members 211u, 211b, attached to each lateral member 211u, 211b. As shown, there is a single longitudinally extending support structure 212p that is perpendicular to and medially positioned relative to the upper and lower lateral members 211u, 211b. The at least one longitudinally extending rearwardly positioned longitudinally extending support structure 212p can have a width that is 10-40% a width of the active antenna module 110 and resides behind the space 250 configured to receive the target device, e.g., at least one active antenna module 110, and can attach to the target device. The lateral support structures 211 can couple to the antenna 100.

FIG. 16B shows that the mounting system 210 can be configured so that the lateral members 211u, 211b can terminate into longitudinally extending segments 212a, 212b, respectively. These segments 212a, 212b can face each other and be longitudinally spaced apart from each other. These segments 212 a, 212 b can have a length L that is in a range of 10-30% a length of the longitudinally extending support structure 212p and can be configured to attach to the antenna 100 and/or the active antenna module 110 or other target device, e.g., other communications device such as a remote radio unit or filter unit. While not shown with the mounting system 210′ of FIG. 17B, this configuration with longitudinally extending segments 212a, 212b with the can be used for the mounting system 210′ shown in FIG. 17B.

FIG. 17B shows that the lateral support structures 211u, 211b terminate with outward free ends and are devoid of the longitudinally extending segments 212a, 212b shown in FIG. 16B. This configuration can be used for the mounting system 210 with the pole segments 216 shown in FIG. 16B.

The longitudinally extending support structure 212p can couple/attach to the active antenna module 110 or other target device. For the mounting system 210 shown in FIG. 16B, the pole segments 216 can attach to field installation targets, e.g., horizontal poles of sector frames 300 (FIG. 18). For the mounting system of FIG. 17B, the lateral members 211 can couple directly to field installation targets, e.g., horizontal poles of sector frames 300 (FIG. 18). The lateral members 211 can have the integrated fastener segments 220 with apertures 220a as discussed with respect to FIGS. 14, 15.

Referring now to FIG. 18, a sector frame 300 comprises a plurality of horizontal poles 20, at least two in each sector S of three sectors, S1, S2, S3 (FIG. 3). Typically, a pair 20p of the horizontal poles 20 are used to mount at least two laterally spaced apart antennas 100 in each sector S. That is, the mounting system 210, 210′ holding a respective antenna 100 is directly mounted to first and second horizontal poles 20₁, 20₂. The vertical poles 30, where used, can provide structural support for the sector frame 300 but are spaced apart from each of the antennas 100. In the embodiment shown, the pole segments 216 can provide longitudinal positional adjustment for the respective antenna 100. The vertical poles 30 can also longitudinal, positional adjustment of the horizontal poles 20, and hence the base station antennas 100.

The sector frame 300 can have at least one platform 40, such as a metal mesh platform, that can be directly attached to at least one of the horizontal poles 20 using mounting brackets 44. As shown, there are three platforms 40 and one side of a respective platform 40 can attach to a pair of converging poles 20 and another side can have an arm 41 that extends inwardly to support a bracket 48 that couples to an outer surface of the tower or monopole 310.

To be clear, it is also contemplated that the antenna mounting system 210, 210′ can be configured to be used for single sector or dual sector arrangements and/or for roof top or wall mounting structures and do not require a sector frame 300.

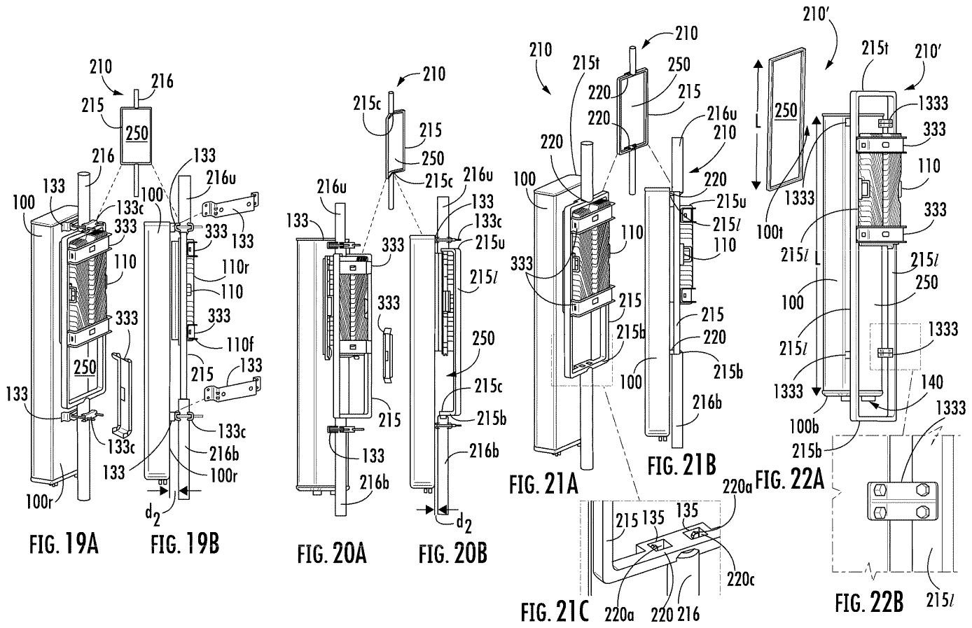

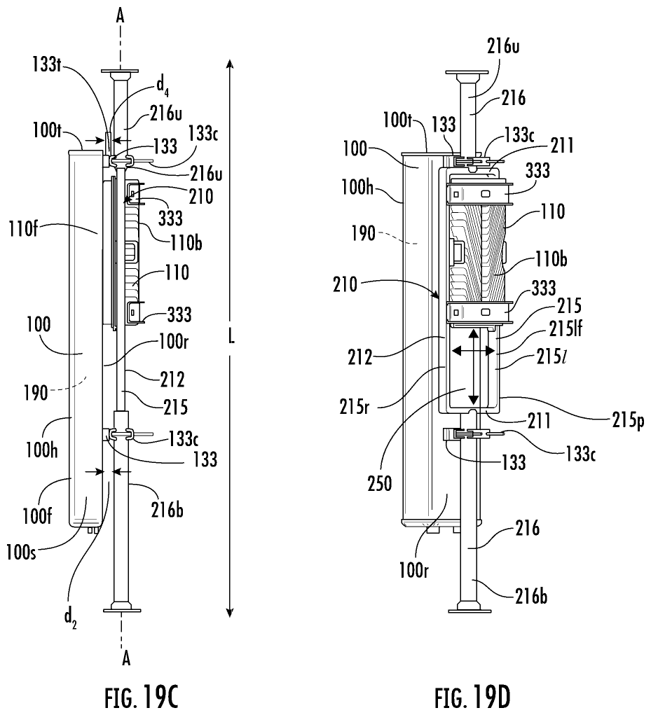

Turning now to FIGS. 19A, 19B, 19C and 19D, the mounting system 210 shown in FIG. 8A, for example, is shown with the frame 215 having a right side 215r and left side 215lf and top 215t and bottom 215b coupled to the right and left sides 215r, 215lf, respectively, providing a perimeter 215p about the space 250 and with the active antenna module 110 occupying a sub-length of the space 250, shown as an upper portion of the space 250. The rear 100r of the antenna 100 can be positioned closely spaced apart from the pole segments 216, a front to back offset distance d2. The distance d2 can correspond to the rearward projection of the bracket 133. The offset distance d2 can be in a range of 0.1-2 inches, more typically 0.1-1 inch.

The rear 110r of the active antenna module 110 can reside behind the frame 215 and behind the pole segments 216u, 216b. As shown, the active antenna module 110 is fixed to the long sides 215l of the frame 215 with brackets 333. The antenna 100 is fixed to the upper and lower pole segments 216u, 216b, respectively, using a respective external antenna bracket 133 and cooperating clamp 133c. The top 100t of the antenna 100 resides adjacent the top 133t external antenna bracket 133 adjacent a lower end 216e of the upper pole segment 216u.

Referring now to FIGS. 20A and 20B, the mounting system 210′ discussed above with respect to FIG. 10 is shown with the antenna 100 and active antenna module 110 coupled thereto. Similar to the description of features of FIGS. 19A-19D, external antenna brackets 133 can be used to attach the mounting system 210 to the upper and lower pole segments 216u, 216b. This configuration may provide a reduced front to back offset d2 between the pole segments 216u, 216b and the rear 100r of the antenna 100 relative to FIGS. 19A-19D, for example. The brackets 333 can be modified to attach to the angled long sides 215l′ of the frame 215. The rear 110r of the active antenna module 110 can be behind, reside flush or reside behind the angled long sides 215l′ of the frame 215.

Turning now to FIGS. 21A, 21B and 21C, the mounting system 210 can be configured to be directly attached to the frame 215 without the use of external clamp brackets 133, 133c (FIGS. 19A-19D, for example). In this embodiment, the top/upper and lower/bottom sides 215u, 215b of the frame 215 can have fastener segments 220 providing tool access channels 220c and apertures 220a that receive respective fasteners 135, such as screws, that affix the mounting system 210 to the antenna 100.

Turning now to FIGS. 22A and 22B, the mounting system 210′ that is devoid of the pole segments 216 can also be configured to attach directly to a respective long side 215l of the frame 215 and a rear 100r of the antenna 100 using angled side brackets 1333. The angled side brackets 1333 can reside above and below the active antenna module 110. The frame 215 can have a length that is greater than a length of the antenna 100 so that a top 215t of the frame 215 resides above a top 100t of the antenna 100 and a bottom 215b of the frame 215 resides below the bottom 100b of the antenna 100. The bottom 100b of the antenna 100 can comprise radio port connectors 140.

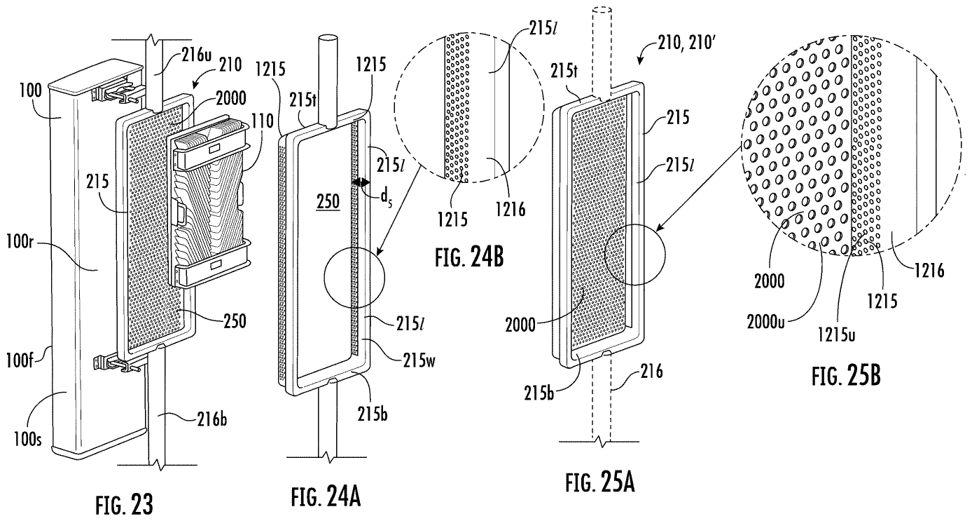

Referring now to FIG. 23, in some embodiments, the mounting system 210, 210′ can comprise a frequency selective surface (FSS) 2000 of one or more layers configured to extend across and along and cover part or all of the space 250 surrounded by the perimeter of the frame 215. The FSS 2000 can reduce energy leakage and/or reduce PIM. The FSS 2000 can be configured to block radiation in one or more frequency ranges, such as low band and/or mid band, and allow radiation to propagate through in another one or more frequency range, such as in a high band frequency range, e.g., a frequency range comprising about 3.5 GHz. The FSS 2000 can allow electromagnetic waves from radiating elements in at least part of a 2.5GHz or greater frequency band, such as in a 3.1-4.2 GHz frequency band to pass therethrough. The FSS 2000 can have a pattern of unit cells in sheet metal. The FSS 2000 can have a pattern of unit cells provided by conductive patches in or on a dielectric substrate or film. The FSS 2000 can be configured to allow RF energy in at least part of a 3.1-4.2 GHz frequency band to propagate therethrough.

Referring to FIGS. 24A and 24B, the sidewalls 215w of the frame 215 can comprise a frequency selective surface (FSS) 1215. The FSS 1215 can reside in front of a solid wall segment 1216 as shown, or extend a full distance d5, in the front to back direction, of one or more of the respective sidewalls 215w. The FSS 1215 can be provided on each of the long sides 215l and the top and bottom 215 t, 215 b or only on the long sides 215l. The FSS 1215 can be configured to block radiation in one or more frequency ranges, such as low band and/or mid band, and allow radiation to propagate through in another one or more frequency range, such as in the high band frequency range.

FIGS. 25A and 25B show that the mounting system 210, 210′ can include both the center cover FSS 2000 and the sidewall FSS 1215, each of which may have FSS unit cells 2000u, 1215u, which may be arranged in different sizes, shapes, densities and/or patterns. The center FSS 2000 can have different configurations of unit cells 2000u at different locations for different blocking, reflecting or propagation ability for different frequencies.

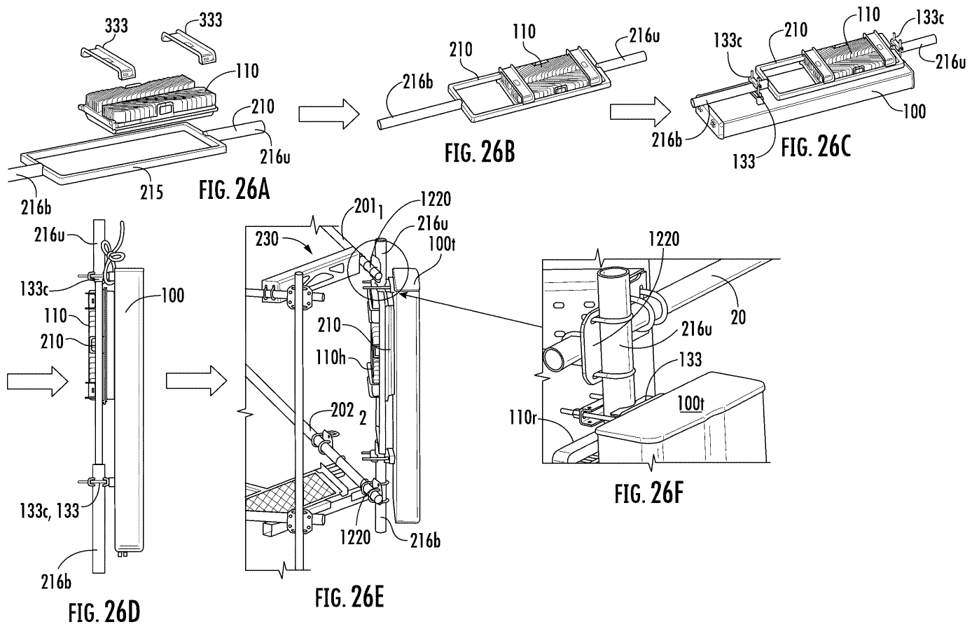

Turning now to FIGS. 26A-26F, an example installation/assembly sequence is shown. The active antenna module 110 can be attached to the mounting system 210, then the antenna 100 can be attached to the mounting system 210, in front of the active antenna module 110, then the assembly can be lifted/hoisted (FIG. 26D) into position to attach to a field support structure (FIGS. 26E, 26F) using brackets 1220. As shown, the upper pole segment 216u is directly attached to a first (upper) horizontal pole 201 using a first bracket 1220 and the lower pole segment 216b is attached to a second (lower) horizontal pole 20₂ using a second bracket 1220. The horizontal poles 20 can form part of a sector frame 300 (FIG. 26E).

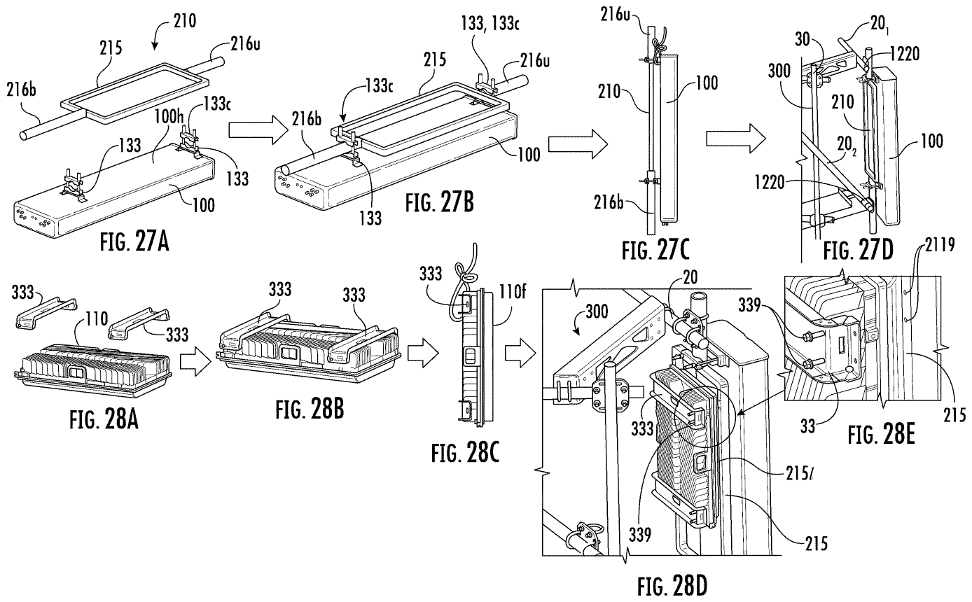

FIGS. 27A-27D show another example installation/assembly sequence according to embodiments of the present invention. In this embodiment, the mounting system 210, 210′ can be provided as a standalone installation, with or without an antenna 100. As shown, the antenna 100 and the mounting system 210, 210′, assembled together, can be lifted into position (FIG. 27C) and attached to a field support structure, such as horizontal poles 20₁, 20₂ of a sector frame 300, using brackets 1220 (FIG. 27D).

FIGS. 28A-28E show an example sequence of actions that allows an active antenna module 110 (or other communications device) to be installed to the mounting system 210, 210′ after the mounting system 210, 210′ is installed at a field site. The active antenna module 110 can be lifted into position (FIG. 28C) and fasteners 339 extending through a side of the bracket 333 can be aligned with apertures 2119 in the frame 215 to attach the active antenna module 110 to the mounting system 210.

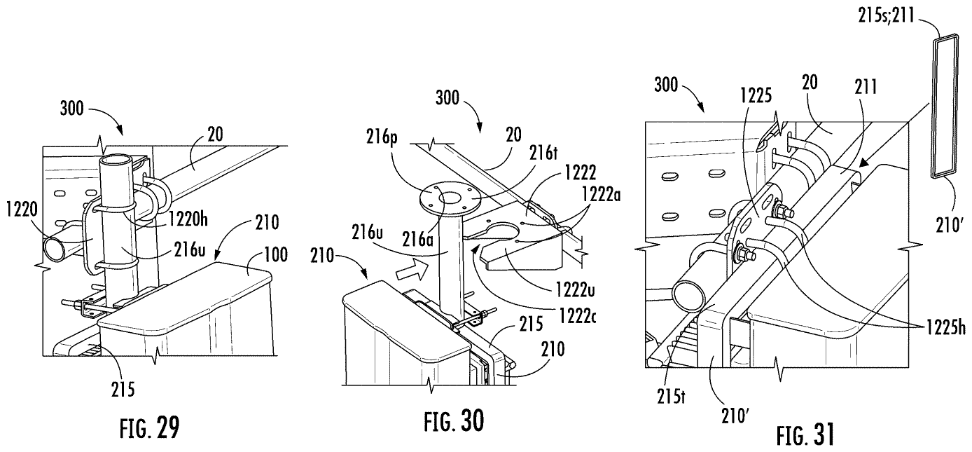

Turning now to FIGS. 29, 30 and 31, example installation interface configurations of the mounting system 210, 210′ are shown. FIG. 29 shows that the pole segment 216, shown as the upper pole segment 216u, can have a cylindrical shape with an open top (which, of course, can be capped or otherwise closed). The bracket 1220 is directly attached to both the horizontal pole 20 and the upper pole segment 216u.

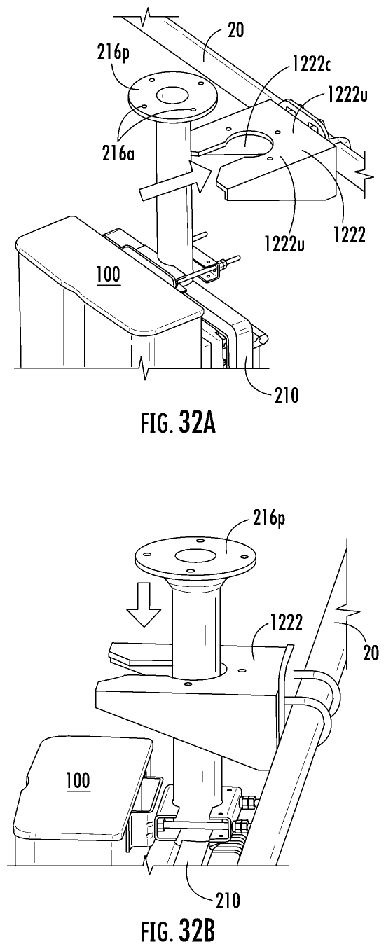

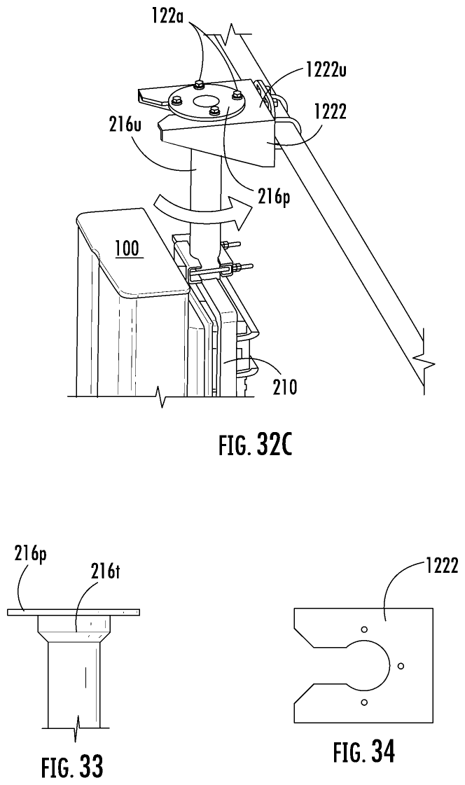

FIG. 30 shows a quick mount configuration where the pole segment 216, shown as the upper pole segment 216u has a top 216t with a plate 216p which may be circular and with an increased diameter relative to the pole 216. The plate 216p can comprise a plurality of spaced apart apertures 216a. The bracket 1222 attached to the horizontal pole 20 has an open forward-facing channel 1222c and the bracket 1222 can also have a plurality of apertures 1222a spaced apart about the channel 1222c. As shown in FIGS. 32A-32C, the pole segment 216 is slidably positionable in the channel 1222c and the pole segment 216 can slide down to position the plate 216p on an upper surface 1222u of the bracket 1222 with apertures 216a aligned with the apertures 1222a of the bracket 1222 into an installation position and fasteners 1229 can be used to secure the plate 216p to the bracket 1222. The pole segment 216 can be rotated in the channel 1222c to adjust horizontal and azimuth orientations prior to inserting the fasteners 1229 into the apertures 1222a. FIGS. 33 and 34 show an upper portion of the pole segment 216 with the plate 216p and the bracket 1222, respectively. The lower pole segment 216b can have the same or a different configuration as the upper pole segment 216u, e.g., it is not required to have the quick connect configuration shown in FIG. 30.

FIG. 31 shows the mounting system 210′ can have a short side 215s of the frame 215 directly attached to the bracket 1225 on the horizontal pole 20 of the sector frame 300 using hoops 1225h. Where a frame is not used, such as the embodiment shown in FIG. 17B, the lateral strut 211u can be directly attached to the bracket 1225 on the horizontal pole 20.

The mounting system 210, 210′ can cooperate with the support poles 201, 202 to position the rear 110r of the active antenna module 110 behind the support poles 201, 202, in some embodiments. The mounting system 210, 210′ can provide a low front to back offset, a lower weight or more balanced load and a compact field support configuration with a lower wind profile compared to conventional configurations. For mounting systems 210 with pole segments 216, the pole segments 216 can have a length that is in a range of 10-40% of a length of the base station antenna 100.

Referring to FIG. 35, a sector frame 300 with four mounting systems 210 with respective base station antennas 100 and active antenna modules 110 per sector is shown. More or less numbers of such mounting systems 210 and antennas 100 may be used. A shown, no continuous length vertical pole 30 is required to be aligned with a longitudinally extending centerline of an antenna housing 100h. Also, no continuous length vertical poles 30 are used to directly attach to the base station antennas 100 as the mounting systems 210, 210′ directly attach to horizontal poles 20. Also, two external brackets 133 (FIGS. 19A-19D), 1333 (FIG. 22A) or fasteners 135 without external brackets (FIG. 21C) can be used to attach the mounting system 210, 210′ with a base station antenna 100 and the mounting system 210, 210′ can attach to two horizontal poles 20₁, 20₂, which may eliminate weight and reduce PIM regions relative to conventional mounting systems.

The antenna 100 may be a base station antenna or other antenna. If a base station antenna 100 then it may be a passive antenna alone without requiring an active antenna or can comprise an active antenna unit 110.

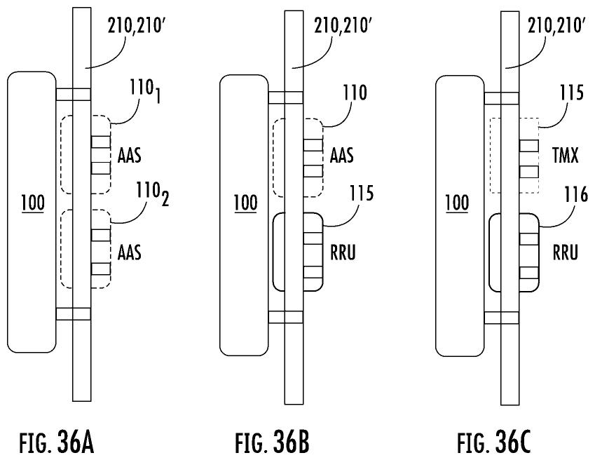

Referring now to FIG. 36A, the mounting system 210, 210′ can mount multiple active antenna modules 110₁, 110₂, one above another.

FIGS. 36B and 36C show that the mounting system 210, 210′ can mount other communication equipment 115 such as remote radio units (RRU), filters or TMX devices with or without the active antenna module 110.

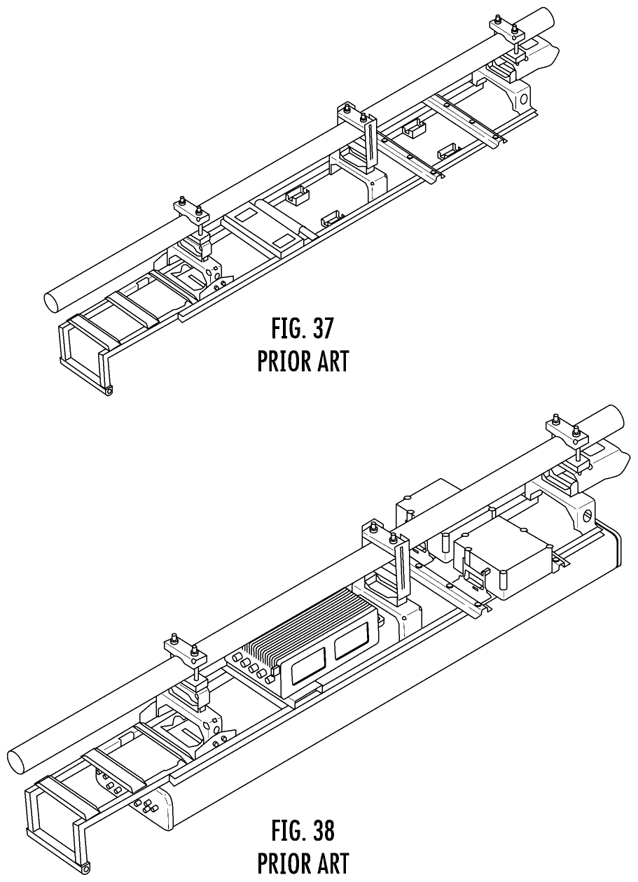

FIGS. 37 and 38 show a prior art mounting system with a single vertical pole 30 and with the mounting system in front of the pole 30 that positions filters 115 and (non-beamforming) radio 116 between the pole 30 and the back of the antenna similar to the prior art configuration shown in FIG. 1.

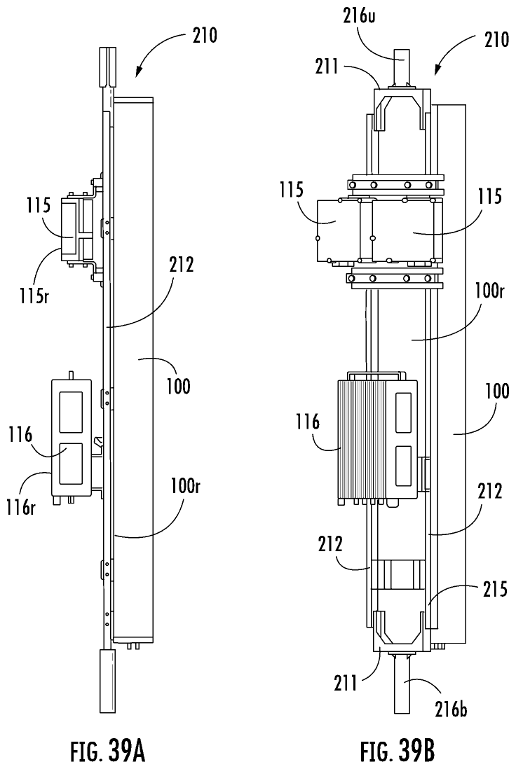

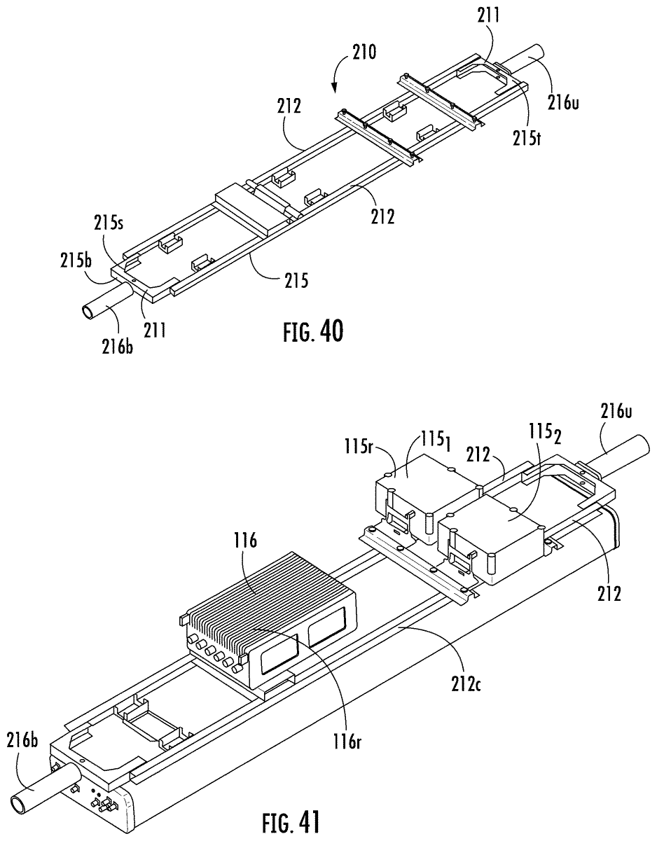

Referring to FIGS. 39A, 39B, 40 and 41, the mounting system 210 can be configured to attach to the rear 100r of the antenna 100 and position the radio 116 and filter units 1151, 1152 with a rear 116r of the radio 116 and a rear 115r of the filters 115 behind the pole segments 216u, 216b. Jumpers can be provided between the filters and radio and/or antenna as will be known to those of skill in the art. The new mounting system 210 can remove the three adaptor brackets used to attach to the pole shown in prior art devices (FIGS. 37, 38) and the frame/pole segment can reduce weight over long pole configurations. The other mounting systems 210′ without the pole segments 216 may also be configured to hold these devices with similar advantages over the cited prior art.

FIG. 41 shows that the longitudinally extending support structure 212 can have a shaped profile 212c such as a “C” or other shaped profile, such as a “U” or “I” to provide increased rigidity, structural support capacity.

FIGS. 40 and 41 also show that the pole segment 216 can be coupled to a lateral support segment 211 that has a “U” shape. The “U” shape can attach to ends of the longitudinally extending support structures 212 forming long sides 215l of a frame 215. The long sides 215l and the short sides 215s of the frame 215 can be sheet metal and may be formed in a number of ways including extrusion, stamping, molding and the like. The frame 215 can be a monolithic structure or provided in segments attached together in any suitable manner including welding, bolting and the like.

It is contemplated that active antenna modules or other devices 110 can be mounted behind antennas 100 and to a field mounting structure in a manner that provides easier installation with less in the airtime demands for installers relative to conventional mounting systems. The devices attached to the mounting system 210, 210′ behind the antenna 100 may be easily placed from behind without requiring insertion from a side or top direction and can provide easier installation.

The base station antenna 100 has a housing 100h. The housing 100h may be substantially rectangular with a flat rectangular cross-section. The housing 100h may be provided to define at least part of a radome with at least the front side 100g configured as a dielectric cover that allows RF energy to pass through in certain frequency bands. The housing 100h may also be configured to that the rear 100r defines a rear side radome opposite the front side radome. Optionally, the housing 100h can also comprise two (narrow) sidewalls. The front side 100f, the sidewalls 100s and typically at least part of the rear side 100r are substantially transparent to radio frequency (RF) energy within the operating frequency bands of the base station antenna 100 and active antenna module 110. The radome may be formed of, for example, fiberglass or plastic.

The new mounting systems 210, 210′ can reduce the weight previously supported by the antenna 100 itself, provide a low wind load, a more balanced weight load, and can reduce the overall weight of the mounting systems for field tower/sector frame installation and provide a back to front installation path for the target devices mounted behind the antennas 100.

The foregoing is illustrative of the present invention and is not to be construed as limiting thereof. Although exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention as defined in the claims. The invention is defined by the following claims, with equivalents of the claims to be included therein.

1. An antenna assembly, comprising:
an antenna;
an active antenna module; and
an antenna mounting system comprising a frame coupled to the antenna and the active antenna module with the active antenna module behind the antenna,
wherein the frame has a top short side that is attached to a field mounting structure or that merges into a pole segment that is attached to the field mounting structure, and wherein a rear of the active antenna module resides behind the field mounting structure.

2. The antenna assembly of claim 1, wherein the field mounting structure comprises a horizontal pole, and wherein attachment hoops are attached to the top short side of the frame and to a bracket that is also attached to the horizontal pole to thereby attach the top short side of the frame to the field mounting structure.

3. The antenna assembly of claim 1, wherein the top short side of the frame merges into the pole segment and the rear of the active antenna module resides behind the pole segment.

4. The antenna assembly of claim 3, wherein the pole segment is an upper pole segment, and wherein the frame comprises a bottom short side that merges into a lower pole segment that is spaced apart from the upper pole segment.

5. The antenna assembly of claim 1, wherein the frame has a perimeter that encloses a space, and wherein the mounting system further comprises a frequency selective surface extending along and across at least part of the space.

6. The antenna assembly of claim 1, wherein sidewalls of the frame comprise a frequency selective surface.

7-9. (canceled)

10. An antenna mounting system assembly comprising:
an antenna mounting system comprising a frame having a perimeter extending about a space, an upper pole segment extending above a top side of the frame and a lower pole segment extending below a bottom side of the frame, wherein the space has a length that is greater than a length of the upper pole segment and a length of the lower pole segment; and
an antenna residing in front of the frame;
wherein at least one communications device is configured to couple to the frame and reside behind the antenna, and wherein at least part of the communications device resides in a plane that is behind the upper and lower pole segments.

11. The antenna mounting system of claim 10, wherein the frame has an access channel and aperture configured to receive a fastener to couple the frame to an antenna.

12. The antenna mounting system assembly of claim 10, wherein the at least one communications device comprises at least one active antenna module, wherein the space has a length that is greater than a length of the active antenna module.

13. The antenna mounting system assembly of claim 10, wherein the frame comprises sidewalls comprising a frequency selective surface and/or wherein a frequency selective surface extends at least partially along and across the space.

14. A sector mounting system, comprising:
a three-sector mounting assembly configured to mount to an antenna tower or monopole and comprising a plurality of horizontal poles configured to mount to the antenna tower or monopole, at least a first horizontal pole and a second horizontal pole spaced apart in a longitudinal direction, for each of the three sectors; and
a plurality of antennas, at least two for each sector, each antenna comprising an antenna mounting system comprising at least one longitudinally extending support structure, wherein the antenna mounting system of a respective antenna is attached to the first and second horizontal poles.

15. The sector mounting system of claim 14, wherein at least one of the plurality of antennas further comprises a communications device mounted to the respective antenna mounting system, behind the corresponding antenna, and wherein a rear surface of the communications device is behind the first and second horizontal poles attached to the antenna mounting system.

16. The sector mounting system of claim 14, wherein the antenna mounting system comprises a frame having a perimeter surrounding a space, and wherein the frame is attached to the antenna and is also configured to attach to a communications device positioned behind the antenna and the frame.

17. The sector mounting system of claim 14, wherein the frame comprises a top side that is attached to the first horizontal pole.

18. The sector mounting system of claim 17, wherein the frame comprises a bottom side that is longitudinally spaced apart from the top side and resides below the antenna, and wherein the bottom side of the frame is attached to the second horizontal pole.

19. The sector mounting system of claim 14, wherein the antenna mounting system comprises first and second longitudinally spaced apart and vertically aligned upper and lower pole segments, wherein the upper pole segment is attached to the first horizontal pole and the lower pole segment is attached to the second horizontal pole.

20. The sector mounting system of claim 16, wherein the antenna mounting system comprises a frequency selective surface extending over at least a portion of the space.

21. The sector mounting system of claim 14, wherein sidewalls of the frame comprise a frequency selective surface.

22. The sector mounting system of claim 14, wherein the antenna mounting system comprises at least one longitudinally extending support structure that resides behind a lateral support structure a distance in a range of 2-8 inches.

23. The sector mounting system of claim 14, further comprising an active antenna module attached to at least one of the antenna mounting systems, residing behind a corresponding antenna, with a rear of the active antenna module residing behind the first and second horizontal poles attached to the antenna mounting system that is also attached to the active antenna module.

24-26. (canceled)
